(19) United States
(12) Patent Application Publication
(10) Pub. No.: US 2013/0329193 A1
(43) Pub. Date: Dec. 12, 2013

(54) PROJECTION APPARATUS

(71) Applicant: CANON KABUSHIKI KAISHA, Tokyo (JP)

(72) Inventor: Eisaku Tatsumi, Kawasaki-shi (JP)

(73) Assignee: CANON KABUSHIKI KAISHA, Tokyo (JP)

(21) Appl. No.: 13/904,119

(22) Filed: May 29, 2013

(30) Foreign Application Priority Data
Jun. 8, 2012 (JP) 2012-131393

(51) Int. Cl. G03B 21/20

(52) U.S. Cl. CPC G03B 21/2053
USPC 353/31; 353/85; 353/81

(57) ABSTRACT

In a projection apparatus, a polygon mirror transforms light from a light source into a two-dimensional luminous flux. A liquid crystal panel performs spatial light modulation of the luminous flux incident from the polygon mirror, based on image data. An image adjusting circuit controls the amount of luminous flux for each predetermined control unit based on the gradation distribution of the image data.

### BACKGROUND OF THE INVENTION

1. Field of the Invention

The present invention relates to a projection apparatus such as a projector.

2. Description of the Related Art

A projection apparatus which employs a liquid crystal display device (LCD) dynamically adjusts the amount of luminous flux in accordance with a display image using a diaphragm for adjusting a luminous flux used to project an image. That is, high-contrast display is allowed by stopping down the aperture of the diaphragm when the average picture level (APL) of an image is low, while opening this aperture when the APL is high.

However, if a white region is present in an image with a low APL, the amount of luminous flux in the white region may decrease due to the stop-down of the aperture to deteriorate a sense of white shine. In contrast, in an image with a high APL, the amount of luminous flux in a black region may increase to generate a so-called “misadjusted black level.”

A technique described in Japanese Patent Laid-Open No. 2010-156744 arranges a second optical modulation device between a light source and an optical modulation device, and controls light from the light source for each fine region in an image using the second optical modulation device. However, an optical modulation device is the most expensive component in a projection apparatus, so the cost of the projection apparatus considerably rises upon addition of a second optical modulation device.

Japanese Patent Laid-Open No. 2008-051963 discloses a technique which uses a linear light source and a linear optical modulator. However, a linear optical modulator requires switching for each line in an image, and can be implemented only by a ferroelectric liquid crystal for a liquid crystal optical modulator. Despite this, a ferroelectric liquid crystal is incapable of gradation display, and is not used for a projection apparatus. Further, a modulation device incapable of high-speed switching must be a planar optical modulator.

Japanese Patent Laid-Open No. 2004-264776 discloses a technique which uses a linear RGB light source and a planar monochrome optical modulator. In a color optical modulator which employs a monochrome optical modulator, there is no need to irradiate the optical modulator with RGB light at different times, thus requiring no light scanning mechanism for this purpose. However, Japanese Patent Laid-Open No. 2004-264776 describes no unit which divides a region in an image to change the amount of light, and therefore cannot increase the contrast of the image.

Japanese Patent Laid-Open No. 2006-153952 discloses a technique which uses a neutral density (ND) filter to reduce the amount of luminous flux of an overlap portion in a multi-projector configuration. This technique can reduce the amount of luminous flux of the overlap portion using the ND filter, but requires a mechanism which precisely moves the ND filter, thus making highly accurate position control difficult, and raising the cost.

### SUMMARY OF THE INVENTION

In one aspect, a projection apparatus comprising: a light source; an optical scanner configured to transform light from the light source into a two-dimensional luminous flux; an optical modulator configured to perform spatial light modulation of the luminous flux incident from the optical scanner, based on image data; and a controller configured to control an amount of light emission by the light source for each predetermined control unit, based on a gradation distribution of the image data.

According to the aspect, it is possible to control the amount of luminous flux from a light source for each region on a screen.

Further features of the present invention will become apparent from the following description of exemplary embodiments with reference to the attached drawings.

### BRIEF DESCRIPTION OF THE DRAWINGS

FIG. 1 is a view for explaining the mechanism configuration of a projection apparatus according to the first embodiment.

FIG. 2 is a view showing the relationship among a light source, an unevenness correction plate, a condenser, and a polygon mirror.

FIG. 3 is a block diagram showing the functional configuration of a projection apparatus which employs a linear white LED array (light source) and a liquid crystal panel.

FIGS. 4A to 4F are schematic views for explaining the light emitting states of the LEDs.

FIGS. 5A and 5B are graphs for explaining the light emitting state of one LED which constitutes the linear white LED array.

FIGS. 6A and 6B are views for explaining the mechanism configuration of a projection apparatus according to the second embodiment.

FIG. 7 is a view illustrating an example of a mechanism which swings a light source at high speed.

FIG. 8 is a view illustrating another example of a mechanism which swings a light source at high speed.

FIGS. 9A and 9B are views for explaining the mechanism configuration of a projection apparatus according to the third embodiment.

FIG. 10 is a view for explaining the light emitting states of LEDs when a video image is projected using four projectors in the fourth embodiment.

FIG. 11 is a view for explaining the mechanism configuration of a projection apparatus according to the fifth embodiment.

FIG. 12 is a view for explaining the mechanism configuration of a projection apparatus according to the sixth embodiment.

FIGS. 13A to 13D are schematic views for explaining the light emitting states of LEDs according to the sixth embodiment.

FIG. 14 is a view for explaining the mechanism configuration of a projection apparatus according to the seventh embodiment.

FIG. 15 is a view for explaining the mechanism configuration of a projection apparatus according to the eighth embodiment.

FIGS. 16A to 16F are schematic views for explaining the light emitting states of LEDs.

### DESCRIPTION OF THE EMBODIMENTS

A projection apparatus according to an embodiment of the present invention will be described in detail below with reference to the accompanying drawings.

The present invention relates to a projection apparatus such as a projector which employs a light emitting diode (LED) as a light source, and a hold display device formed by, for example a liquid crystal as an optical modulation device, and to a driving method and scanning method for a light source in projection display of an image or a video image, as will be described later. The present invention also relates to a method of synchronizing a light source and an optical modulation device. The present invention moreover relates to a driving method and scanning method for a light source when one large screen is displayed using a plurality of projectors.

### First Embodiment

[Mechanism Configuration]

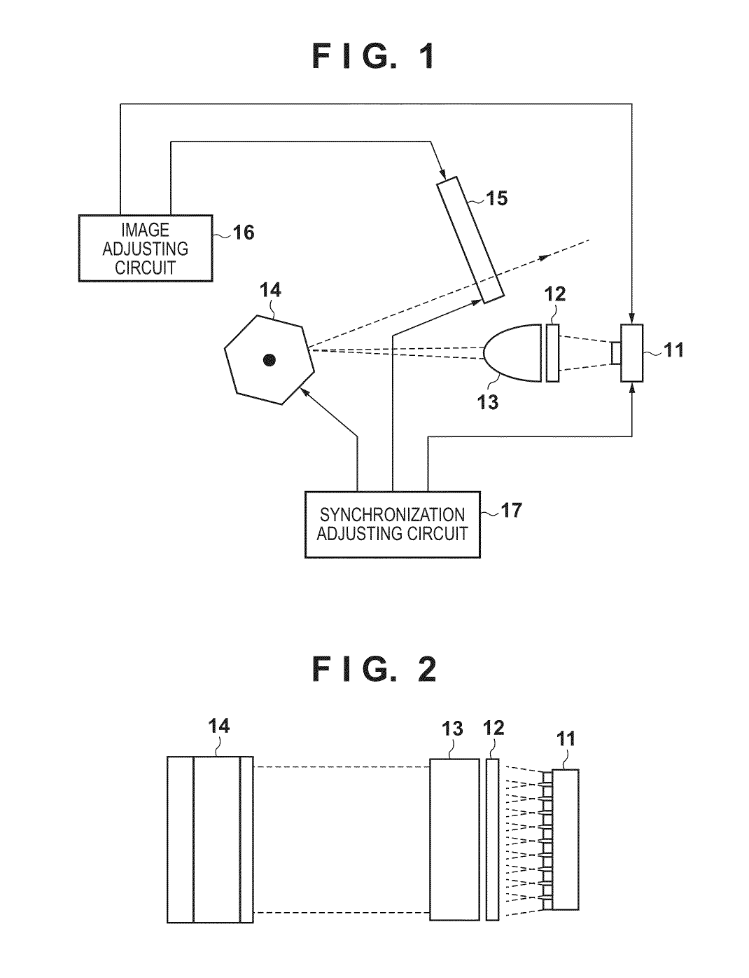

A projection apparatus according to the first embodiment scans light using a linear white light emitting diode array (to be referred to as a white LED array hereinafter) as a light source to scan light, and performs spatial light modulation using a liquid crystal panel. The mechanism configuration of the projection apparatus according to the first embodiment will be described with reference to FIG. 1.

Referring to FIG. 1, a light source 11 is a linear white LED array. An unevenness correction plate 12 corrects the unevenness of brightness generated by a plurality of LEDs. A condenser 13 condenses light having passed through the unevenness correction plate 12. A polygon mirror 14 two-dimensionally scans a linear luminous flux. A liquid crystal panel (LCD) 15 serves as a spatial light modulation device.

An image adjusting circuit 16 controls the liquid crystal panel 15 and light source 11 in accordance with image data to be displayed. A synchronization adjusting circuit 17 is configured to match the timings of the light source 11, polygon mirror 14, and liquid crystal panel 15.

Although the linear white LED array serving as the light source 11 is assumed to have a plurality of LEDs linearly aligned in one line herein, it may have LEDs aligned in, for example, two lines in a staggered pattern when each LED has a large size. Also, although it is desired to use the unevenness correction plate 12 to correct the unevenness of luminous flux as the front sides of the LEDs are bright while the gaps between the LEDs are dark, the unevenness correction plate 12 may be omitted when a large number of LEDs are used to keep the unevenness of luminous flux small.

FIG. 2 shows the relationship among the light source 11, the unevenness correction plate 12, the condenser 13, and the polygon mirror 14. The condenser 13 condenses light which is emitted by the LEDs and diverges toward the front, and transforms it into linear collimated light. The linear collimated light incident on the polygon mirror 14 is two-dimensionally scanned upon rotation of the polygon mirror 14. The two-dimensionally scanned light strikes the liquid crystal panel 15, and a luminous flux modulated by an image displayed on the liquid crystal panel 15 is output. Note that the modulated luminous flux is projected onto a screen (not shown) by a projection lens (not shown).

It is desired to define the line direction in which the LEDs are arrayed on the abscissa of the liquid crystal panel 15, and the optical scanning direction of the polygon mirror 14 on the ordinate of the liquid crystal panel 15 to match this scanning direction with the scanning direction at the time of capturing an image. However, display can be done even when the ordinate and abscissa of the liquid crystal panel 15 are interchanged with each other, so the relationship between the line and scanning directions may be opposite to the above case in terms of the internal arrangement of the projection apparatus.

[Functional Configuration]

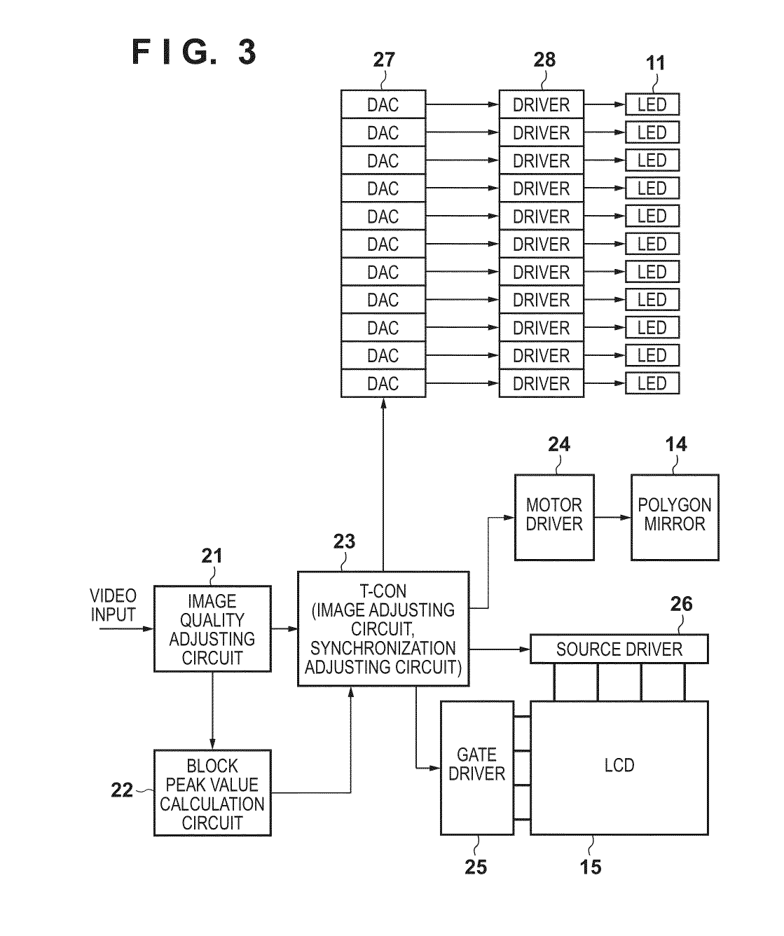

FIG. 3 is a block diagram showing the functional configuration of a projection apparatus which employs the linear white LED array (light source 11) and liquid crystal panel 15.

Referring to FIG. 3, an image quality adjusting circuit 21 adjusts the quality of an input video image in accordance with the settings of a display device or audience. A block peak value calculation circuit 22 calculates a peak picture level for each unit region of light source control. A timing controller (T-CON) 23 includes the image adjusting circuit 16 and synchronization adjusting circuit 17 shown in FIG. 1, matches the timings of the light source 11, polygon mirror 14, and liquid crystal panel 15, and controls/adjusts the brightness.

A motor driver 24 drives the polygon mirror 14. A gate driver 25 and a source driver 26 drive the liquid crystal panel 15. A digital-to-analog converter (DAC) array 27 converts a digital signal input from the T-CON 23 into an analog signal. A driver array 28 drives each LED in accordance with the analog signal output from the DAC array 27.

[Operation]

The projection apparatus receives a video signal (YPbPr signal), and outputs, to the block peak value calculation circuit 22 and T-CON 23, an RGB signal obtained by performing image quality adjustment for the input video signal by the image quality adjusting circuit 21 using the audience's preferences and the characteristics of the liquid crystal panel 15 as parameters. The block peak value calculation circuit 22 performs comparative calculation of the peak picture level of image data included in a block, and outputs the calculation result as a block peak value.

Note that the number of LEDs included in the light source 11 is equal to the number of blocks in the line direction. When the light source 11 uses, for example, 20 LEDs, 20 blocks are used. That is, as the number of LEDs increases, finer control can be done, but it is desired to use several ten LEDs due to limitations in the cost and the occupied area of the LEDs. The number of controlled objects which undergo light amount control during scanning is equal to the number of blocks in the scanning direction. As the number of blocks in the scanning direction increases, finer control can be done, so the number of blocks in the scanning direction is set to, for example, 200. When 20 LEDs and 200 blocks in the scanning direction are used, a total of 20×200=4000 blocks are used. That is, a block is the control unit of the amount of light, and the number of blocks is the total number of control units.

The block peak value calculation circuit 22 calculates the block peak value of each block, and outputs it to the T-CON 23. The image adjusting circuit 16 of the T-CON 23 determines the amount of luminous flux of each block based on the distribution of the block peak value of this block. A digital value to be supplied to the DAC array 27 is set so as to obtain an amount of luminous flux of, for example, 0.5+0.01=0.51 for a block having a block peak value of 0.5. Note that the value (0.01 in the above case) to be added to the block peak value is a margin for correcting, for example, the unevenness.

The image adjusting circuit 16 multiplies the RGB value by the amount of decrease in amount of luminous flux, that is, the gain corresponding to the reciprocal of the amount of luminous flux. When the amount of luminous flux is, for example, 0.51, the gain is 1/0.51=1.96. The RGB value multiplied by the gain is converted into a digital value indicating a voltage, and the digital value is supplied to the source driver 26 as data.

The synchronization adjusting circuit 17 of the T-CON 23 supplies a timing signal which instructs scanning at 60 Hz to the gate driver 25. The gate driver 25 and source driver 26 drive the source and gate electrodes, respectively, of the liquid crystal panel 15, and a common electrode (not shown) together to display a video image on the liquid crystal panel 15 serving as a spatial light modulation device.

The synchronization adjusting circuit 17 adjusts the timings of the gate driver 25, motor driver 24, and driver array 28. As the most desirable timing, the synchronization adjusting circuit 17 performs synchronization control so that the polygon mirror 14 rotates through the angle at which a luminous flux from the light source 11 enters a line portion immediately before the liquid crystal panel 15 is rewritten by the gate driver 25. With this operation, a linear luminous flux strikes the liquid crystal panel 15 at the timing, at which an image on the liquid crystal is most stable, to obtain best image quality.

Operation of LED Light Source

The T-CON 23 outputs, to each DAC of the DAC array 27, a digital signal corresponding to a voltage value equivalent to a current value to be supplied to the corresponding LED. To set the current value in light emission to 20×0.51=10.2 mA when the voltage value is 2 V for a current value of, for example, 20 mA in light emission of each LED, a digital signal corresponding to a voltage value of 1.02 V (=2×10.2/20) is output.

The driver array 28 drives each LED of the light source 11 using a current value (10.2 mA when the voltage value is, for example, 1.02 V) equivalent to the voltage value input from the DAC array 27 to allow this LED to emit a luminous flux of light in an amount corresponding to an instruction by the T-CON 23.

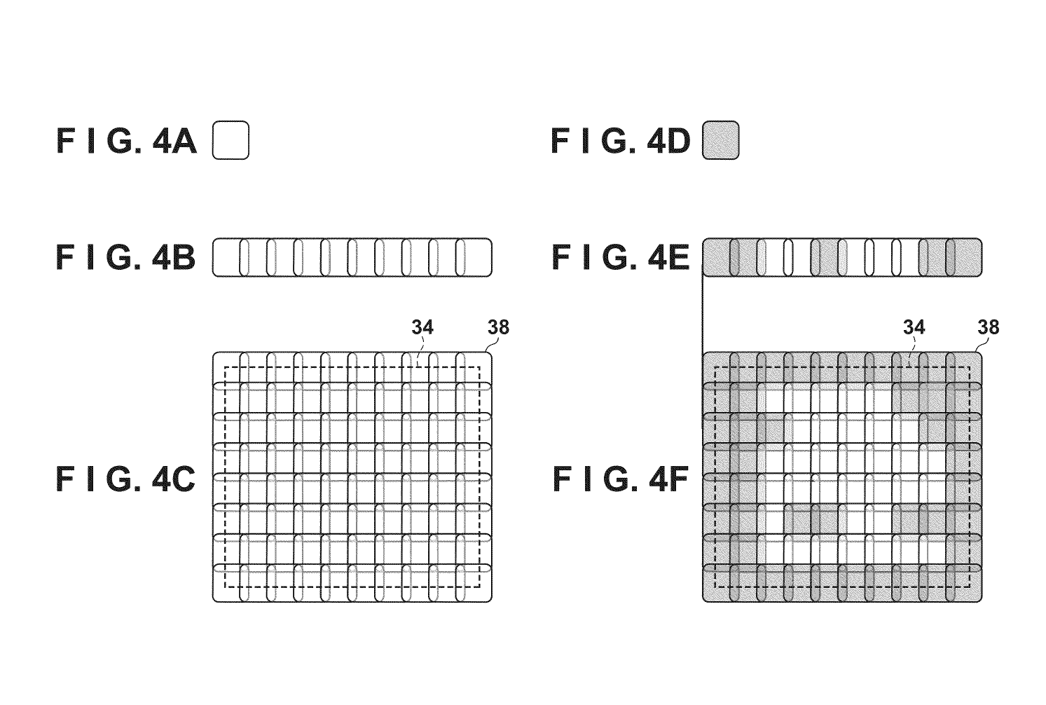

The light emitting states of the LEDs will be described with reference to schematic views shown in FIGS. 4A to 4F. FIG. 4A shows a luminous flux region corresponding to one LED in full light emission, FIG. 4B shows a luminous flux region in the linear LED array in full light emission, and FIG. 4C shows a luminous flux region 38 and a display region 34 on the liquid crystal panel 15 in full light emission when two-dimensional scanning is done.

Also, FIG. 4D shows a luminous flux region corresponding to one LED in half light emission, FIG. 4E shows a luminous flux region in the linear LED array in block control, and FIG. 4F shows a luminous flux region 38 and a display region 34 on the liquid crystal panel 15 when two-dimensional scanning is done upon block control. Note that the half light emission means a light emitting state where the amount of luminous flux is about half that in full light emission.

Although FIGS. 4C and 4F illustrate an example in which 10 (horizontal)×8 (vertical) blocks are used for the sake of simplicity, a large number of blocks are preferably used to attain excellent image quality, so it is desired to use about 20 (horizontal)×200 (vertical)=4,000 blocks, as described above.

The luminous flux region corresponding to one LED (FIGS. 4A and 4D) has an area larger by, for example, 20% than that obtained by dividing the entire area of the luminous flux region 38 by the number of vertical and horizontal blocks, and the light distribution characteristics of the LED device are adjusted so that the peripheral portion of the luminous flux region becomes dark. With this operation, the right and left LED luminous flux regions overlap each other, as shown in the luminous flux region of the linear white LED array (FIGS. 4B and 4E). As for the vertical direction, the upper and lower luminous flux regions similarly overlap each other, as shown in the luminous flux region (FIGS. 4C and 4F) when two-dimensional scanning is done. A gradual change in luminous flux takes place upon vertically scanning the display region 34 using a pulsed current as a current to be supplied to each LED, although details will be described later. As a result, since luminous fluxes of light smoothly overlap each other in adjacent regions in both the vertical and horizontal directions, it is possible to prevent hindrances such as streak interference generated between adjacent regions.

Amount of Light Emission by LED

A full light emission region is present at the central portion of the luminous flux region 38 in an indeterminate form, while a half light emission region is present in other portions, as shown in the luminous flux region 38 (FIG. 4F) when two-dimensional scanning is done upon block control. In scanning a linear luminous flux from the linear white LED array downwards, the amount of light emission by each LED is dynamically changed in accordance with the required amount of light emission.

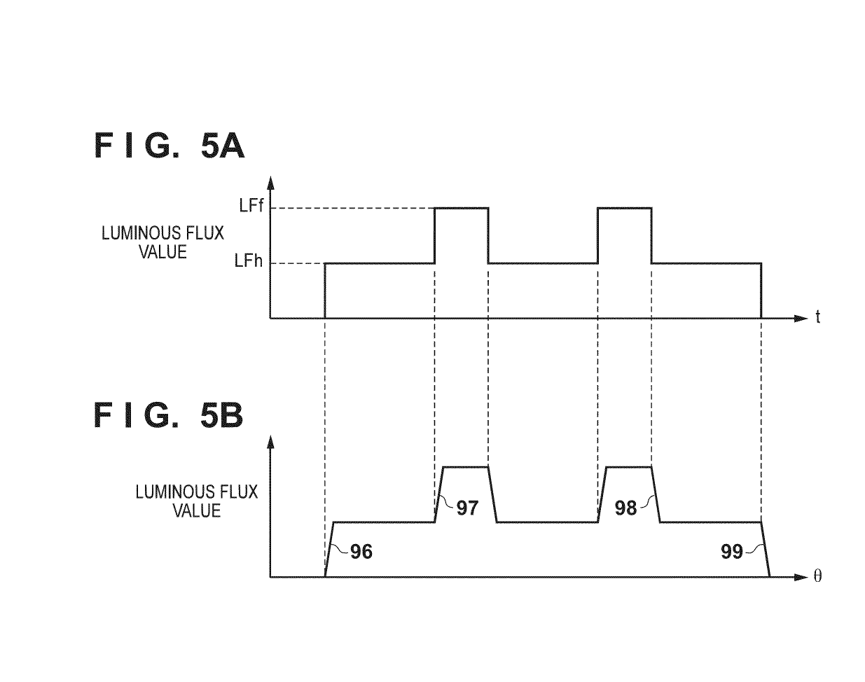

The light emitting state of one LED which constitutes the linear white LED array will be described with reference to FIGS. 5A and 5B. FIG. 5A shows the time t on the abscissa, and the luminous flux value [lm] when the LED emits light on the ordinate. Reference symbol LFf denotes the luminous flux value in full light emission; and LFh, the luminous flux value in half light emission.

FIG. 5B shows the angle θ on the abscissa, and the luminous flux value [lm] on the ordinate. A leading edge portion 96 indicates the luminous flux value outside the upper end of the display region 34 (to be referred to as a “screen” hereinafter) of the liquid crystal panel 15. A leading edge portion 97 indicates the luminous flux value when full light emission is simultaneously done in the course of half light emission. A trailing edge portion 98 indicates the luminous flux value when half light emission is simultaneously done in the course of full light emission. A trailing edge portion 99 indicates the luminous flux value outside the lower end of the screen.

For example, if the luminous flux value of the light source 11 on the entire screen is 200 lm, and the light source 11 has 10 LEDs, the luminous flux value for each LED is 20 lm, so a light flux value of 20 lm is output in a vertically elongated region upon scanning. When the polygon mirror 14 has six faces, 60° is set for each face, and one period of 16.67 ms corresponds to 60°, so a luminous flux from the light source 11 is scanned at a wider angle from outside the upper end to that of the lower end. Of the scanned region, the angle corresponding to the region from the upper to lower ends of the screen 34 is, for example, 48°. When the screen 34 has an angle corresponding to 48°, each block corresponds to an angle of 6°, and the passage time for each block is about 1.7 ms (=16.67/60×6), because 8 blocks are present in the vertical direction in the example shown in FIG. 4F.

FIG. 5A illustrates an example in which one LED performs half light emission, half light emission, full light emission, half light emission, half light emission, full light emission, half light emission, and half light emission in this order for 8 vertical blocks. In the leading edge portion 96 and trailing edge portion 99 shown in FIG. 5B, a luminous flux region corresponds to a portion that falls outside the screen 34, so the amount of luminous flux is expressed as a linear function. Also, if the amount of luminous flux is different between the individual blocks, the amount of luminous flux changes to a linear function, as shown in the leading edge portion 97 and trailing edge portion 98. With this operation, a gradual change in luminous flux is obtained in the vertical direction of the screen 34, as described above.

Although FIGS. 5A and 5B illustrate an example in which the amount of light emission is switched between full light emission and half light emission for the sake of simplicity, the amount of light emission is finely set in accordance with the block peak value, as described above. Also, although FIGS. 5A and 5B show vertical block control for one LED, a two-dimensional luminous flux region, as shown in FIG. 4F, is obtained by block control of all LEDs which constitute the light source 11.

With this arrangement, in the projection apparatus, a large amount of luminous flux comparable to a lamp light source can be obtained using a plurality of LEDs (LED array) for the light source 11. Also, projection display of an image with sharp white peaks or an image free form a misadjusted black level can be obtained by controlling the amount of luminous flux upon division into regions in a number several ten to several hundred times the number of LEDs.

Further, when a multi-projector is built, the amount of luminous flux in an overlap portion between adjacent projection apparatuses can be reduced, so image display on a high-resolution large screen having an overlap portion with a low misadjusted black level can be obtained.

### Second Embodiment

A projection apparatus according to the second embodiment of the present invention will be described below. Note that the same reference numerals as in the first embodiment denote the same constituent elements in the second embodiment, and a detailed description thereof will not be given.

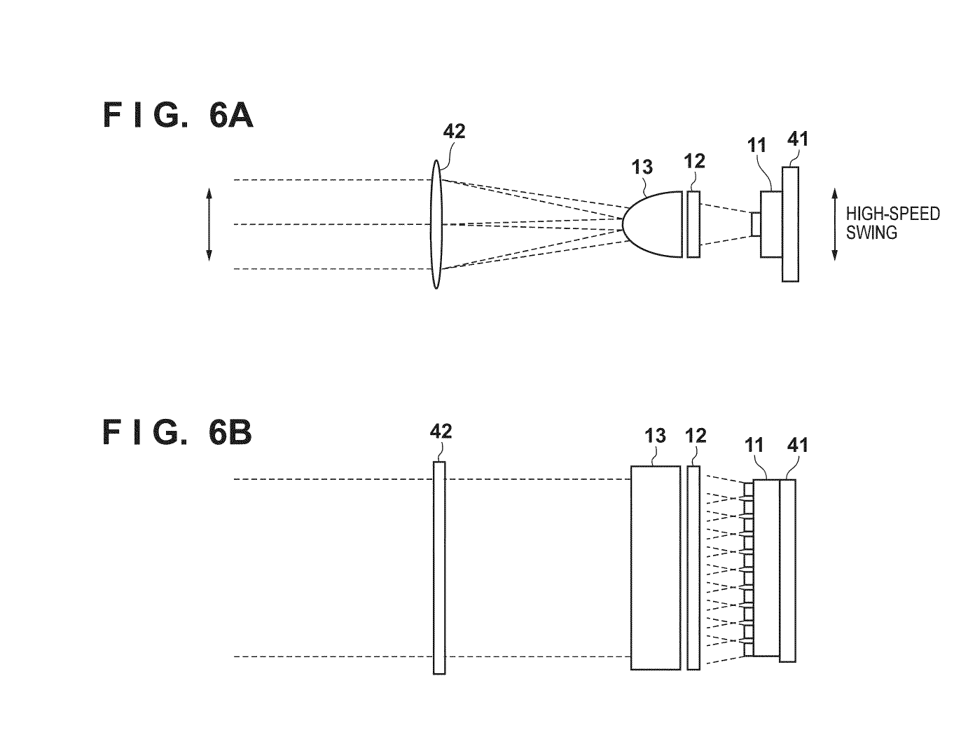

An example in which a light source 11 is vertically swung at high speed to perform vertical optical scanning will be described in the second embodiment. The mechanism configuration of the projection apparatus according to the second embodiment will be described with reference to FIGS. 6A and 6B. Note that FIG. 6A is a side view, and FIG. 6B is a top view.

A mechanism (to be described later) vertically swings a holding unit 41 of the light source 11 at a cycle of 60 Hz, so light output from a condenser 13 is scanned with a vertical tilt. The light is transformed using a lightguide lens 42 with a shape similar to that of a partial circular cylinder, so that collimated light is scanned vertically.

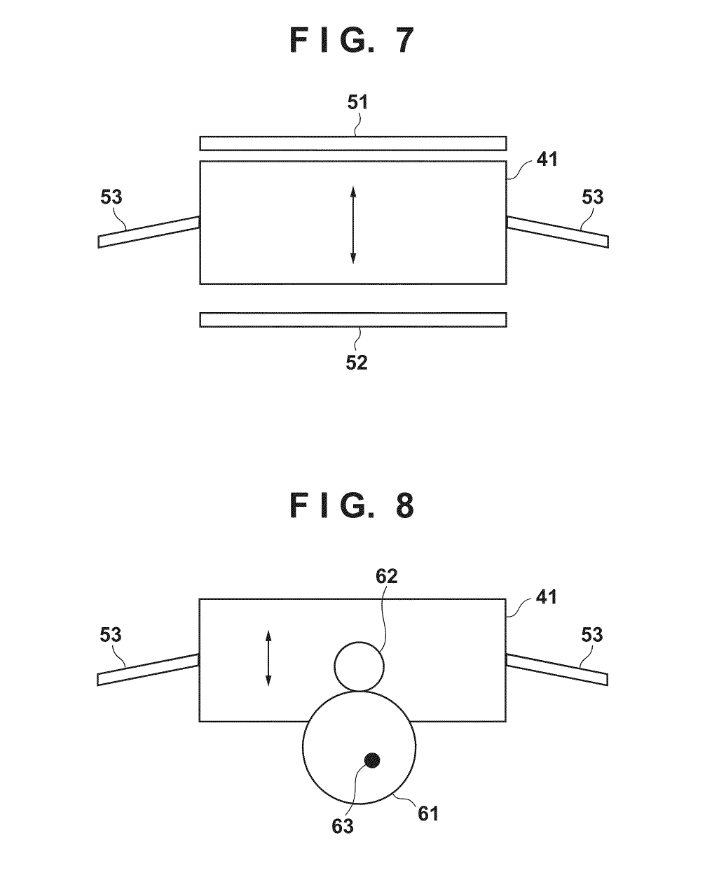

FIG. 7 illustrates an example of a mechanism which swings the light source 11 at high speed. The mechanism shown in FIG. 7 swings the holding unit 41 at high speed using an electromagnetic attractive force and repulsive force. That is, the holding unit 41 is implemented by a permanent magnet, and has an upper end serving as a north pole, and a lower end serving as a south pole. The holding unit 41 is interposed between an opposed, upper inductor 51 and lower inductor 52, and supplies in-phase triangular wave currents to both the upper inductor 51 and lower inductor 52.

If the opposed surface of the upper inductor 51 serves as a north pole, and that of the lower inductor 52 also serves as a north pole, a repulsive force acts between the holding unit 41 and the upper inductor 51, while an attractive force acts between the holding unit 41 and the lower inductor 52. In contrast, if the opposed surface of the upper inductor 51 serves as a south pole, and that of the lower inductor 52 also serves as a south pole, an attractive force acts between the holding unit 41 and the upper inductor 51, while a repulsive force acts between the holding unit 41 and the lower inductor 52.

Right and left leaf springs 53 of the holding unit 41 limit a motion of the holding unit 41 in unwanted directions. Further, the holding unit 41 can be vertically swung at a predetermined speed using a triangular wave for a current to be supplied to the upper inductor 51 and lower inductor 52.

FIG. 8 illustrates another example of a mechanism which swings the light source 11 at high speed. The mechanism shown in FIG. 8 swings the holding unit 41 at high speed using an eccentric pulley 61. The eccentric pulley 61 engages with a shaft 63 of a motor (not shown) which rotates at, for example, 3,600 rpm. A support bar 62 of the holding unit 41 abuts against the circumferential surface of the eccentric pulley 61 by the leaf springs 53. The support bar 62 is vertically swung upon rotation of the vertical eccentric pulley 61.

The holding unit 41 reciprocally swings at a cycle of 60 Hz. When the light source 11 emits light only in the case wherein it swings downwards with respect to a liquid crystal panel 15, good image quality can be obtained. When the light source 11 emits light in the case wherein it swings upwards with respect to the liquid crystal panel 15 as well, a bright projection image can be obtained with good image quality, although not as good as in the former case.

Although the light source 11 vertically swings (translates) at high speed in the above-mentioned example, optical scanning can be similarly done even when the light source 11 moves in a tilt direction using its center as an axis.

In the second embodiment, by changing the position or tilt angle of an array of white LEDs linearly aligned in one line, a large-scale mechanism such as a polygon mirror becomes unnecessary, so the projection apparatus can be downsized.

### Third Embodiment

A projection apparatus according to the third embodiment of the present invention will be described below. Note that the same reference numerals as in the first and second embodiments denote the same constituent elements in the third embodiment, and a detailed description thereof will not be given.

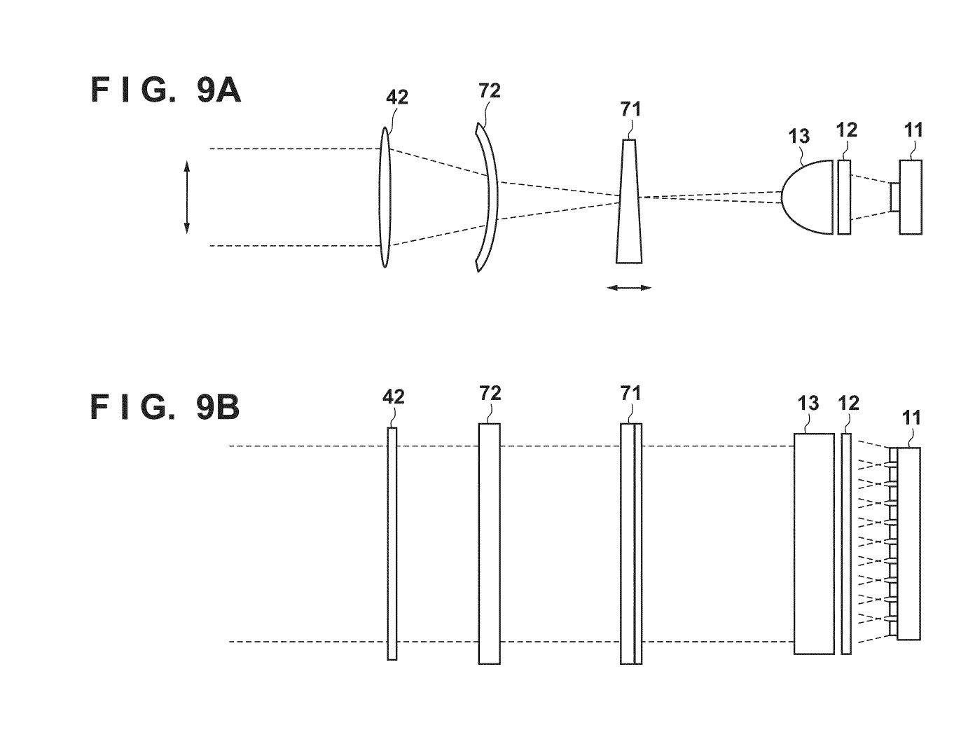

An example in which optical scanning is performed using a variable angle prism will be described in the third embodiment. The mechanism configuration of the projection apparatus according to the third embodiment will be described with reference to FIGS. 9A and 9B. Note that FIG. 9A is a side view, and FIG. 9B is a top view.

A variable angle prism 71 performs an operation similar to camera shake correction. Normally, camera shake correction is performed using a small angle of bend, while an enlarging lens 72 which increases the angle of bend, and a lightguide lens 42 which corrects incident light to collimated light are arranged in subsequent stages when it is desired to considerably bend light, as in this embodiment.

The variable angle prism 71 is swung to have a vertical tilt at a cycle of 60 Hz using an actuator (not shown), as in camera shake correction. With this operation, a luminous flux which is emitted by a light source 11 and focused by an unevenness correction plate 12 and a condenser 13 is two-dimensionally enlarged to reciprocate at a cycle of 60 Hz.

As in the second embodiment, when the light source 11 emits light only in the case wherein it swings downwards with respect to a liquid crystal panel 15, good image quality can be obtained. When the light source 11 emits light in the case wherein it swings upwards with respect to the liquid crystal panel 15 as well, a bright projection image can be obtained with good image quality, although not as good as in the former case.

In the third embodiment, as in the second embodiment, a large-scale mechanism such as a polygon mirror becomes unnecessary, so the projection apparatus can be downsized.

### Fourth Embodiment

A projection apparatus according to the fourth embodiment of the present invention will be described below. Note that the same reference numerals as in the first to third embodiments denote the same constituent elements in the fourth embodiment, and a detailed description thereof will not be given.

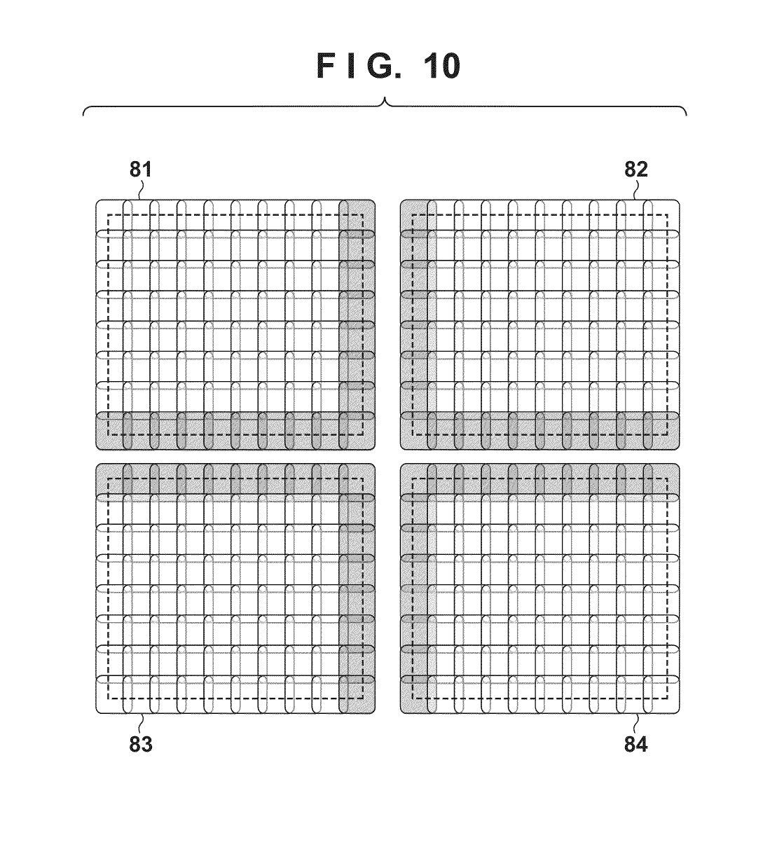

An example in which a linear white LED array is used as a light source in a multi-projector configuration will be described in the fourth embodiment. The light emitting states of LEDs when a video image is projected using four projectors in the fourth embodiment will be described with reference to FIG. 10.

Referring to FIG. 10, a region 81 indicates a luminous flux region when two-dimensional scanning is done upon block control in the upper left projector. Similarly, a luminous flux region 82 corresponds to the upper right projector, a luminous flux region 83 corresponds to the lower left projector, and a luminous flux region 84 corresponds to the lower right projector.

Although FIG. 10 illustrates an example in which 10 (horizontal)×8 (vertical) blocks are used for the sake of simplicity, it is desired to use about 20 (horizontal)×20 (vertical)=400 blocks in terms of the size of an overlap portion in a multi-projector.

It is a common practice to use an edge blending process to make an overlap portion in a multi-projector inconspicuous. In the fourth embodiment, the amount of luminous flux of a light source in the overlap portion is reduced to prevent a misadjusted black level from being generated due to a decrease in contrast of the region having undergone edge blending.

The amount of luminous flux of a light source is reduced in an overlap portion when a multi-projector is configured, as shown in the luminous flux regions 81 to 84. For example, the light amount ratio is set to 0.5+α in an overlap portion where luminous fluxes from two projectors overlap each other, and 0.25+α in an overlap portion where luminous fluxes from four projectors overlap each other. Note that α is the margin of gradation processing, and has a value of about 0.01 to 0.05.

A gradation value G on a screen, which is spatially modulated by a liquid crystal panel 15, is calculated in accordance with:

G=D×k/n/R

where G is the gradation value, D is the pixel value, k is an edge blend coefficient, n is the number of projectors which emit luminous fluxes to overlap each other, and R is the light amount ratio.

The gradation value G and light amount ratio R are controlled by an image adjusting circuit 16 shown in FIG. 1. In the fourth embodiment, a misadjusted black level can be prevented from being generated due to a decrease in contrast of the region having undergone edge blending.

Although a so-called single-panel projection apparatus including only one liquid crystal panel 15 serving as a spatial light modulator has been described in the first to fourth embodiments, the present invention is also applicable to a three-plate projection apparatus which uses a liquid crystal panel for each luminous flux of RGB light.

### Fifth Embodiment

A projection apparatus according to the fifth embodiment of the present invention will be described below. Note that the same reference numerals as in the first to fourth embodiments denote the same constituent elements in the fifth embodiment, and a detailed description thereof will not be given.

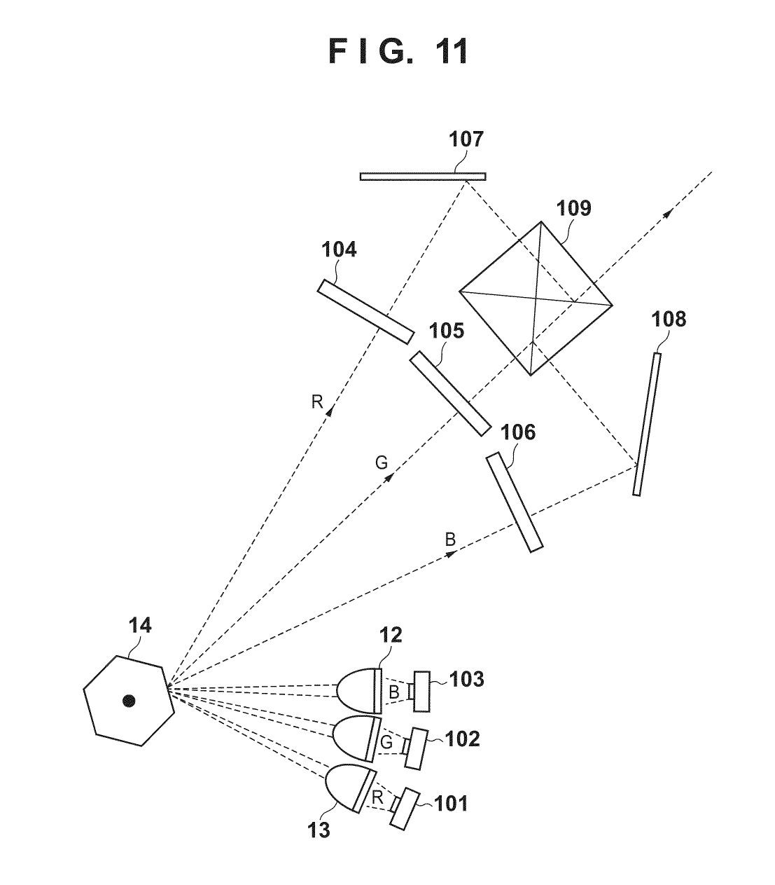

The projection apparatus according to the fifth embodiment employs linear light emitting diode arrays (to be abbreviated as LED arrays hereinafter) of three colors as a light source to scan light, and performs spatial light modulation using three liquid crystal panels. The mechanism configuration of the projection apparatus according to the fifth embodiment will be described with reference to FIG. 11.

Referring to FIG. 11, a light source 101 has a linear red light emitting diode array (to be abbreviated as a “red LED array” hereinafter). A light source 102 has a linear green light emitting diode array (to be abbreviated as a “green LED array” hereinafter). A light source 103 has a linear blue light emitting diode array (to be abbreviated as a “blue LED array” hereinafter). A liquid crystal panel 104 serves as a spatial light modulator for red display (to be abbreviated as “R display” hereinafter), a liquid crystal panel 105 serves as a spatial light modulator for green display (to be abbreviated as “G display” hereinafter), and a liquid crystal panel 106 serves as a spatial light modulator for blue display (to be abbreviated as “B display” hereinafter). A mirror 107 is a reflecting mirror for red, a mirror 108 is a reflecting mirror for green, and a prism 109 is a combining prism which combines luminous fluxes of the three colors.

R light from the light source 101 is corrected to linear collimated light by a condenser 13 through an unevenness correction plate 12, and strikes the R liquid crystal panel 104 upon scanning of a polygon mirror 14. Similarly, G light from the light source 102 strikes the G liquid crystal panel 105 upon scanning of the polygon mirror 14, and B light from the light source 103 strikes the B liquid crystal panel 106 upon scanning of the polygon mirror 14.

After spatial light modulation by the liquid crystal panels, the R light and B light are reflected by the reflecting mirrors 107 and 108, respectively, and guided to the combining prism 109. The luminous fluxes of the three colors are combined by the combining prism 109, and projected onto a screen (not shown) upon being enlarged by a projection lens (not shown).

Although FIG. 11 illustrates an example in which only one polygon mirror 14 is used, it is obvious that a total of three polygon mirrors may be used for the respective colors. Also, a three-panel projection apparatus can be implemented using three optical scanners which scan the position and tilt angle shown in the second and third embodiments.

An example in which light from a linear LED array is scanned, is two-dimensionally expanded, and enters a spatial light modulator has been described in the first to fifth embodiments. If a small number of blocks which control the amounts of luminous flux need only be used, the projection apparatus can also be implemented using a two-dimensional LED array.

### Sixth Embodiment

A projection apparatus according to the sixth embodiment of the present invention will be described below. Note that the same reference numerals as in the first to fifth embodiments denote the same constituent elements in the sixth embodiment, and a detailed description thereof will not be given.

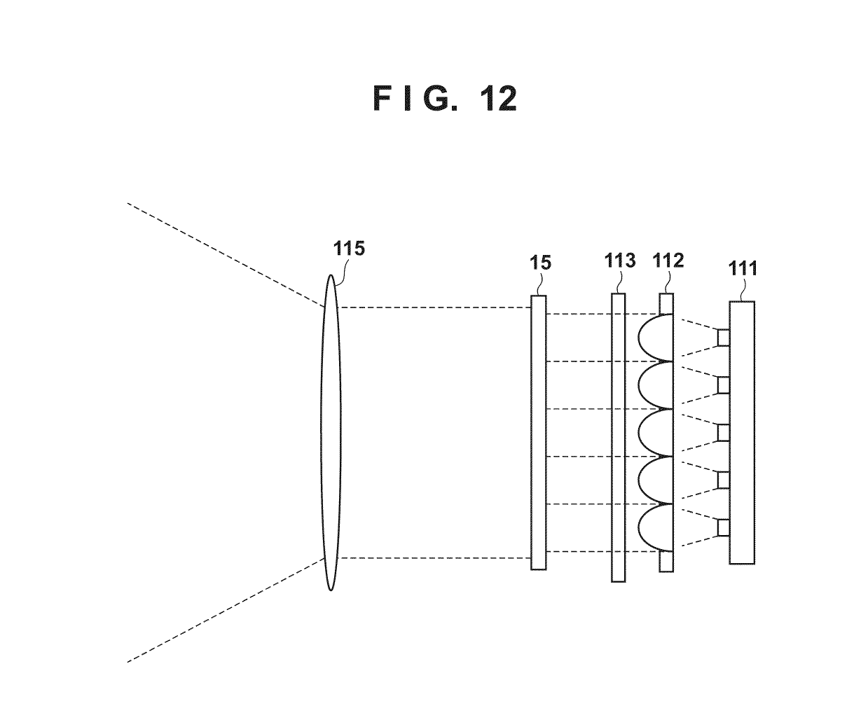

The projection apparatus according to the sixth embodiment uses a two-dimensional white LED array as a light source, and performs spatial light modulation using a liquid crystal panel. The mechanism configuration of the projection apparatus according to the sixth embodiment will be described with reference to FIG. 12.

Referring to FIG. 12, a light source 111 is a two-dimensional white LED array, and a lens array 112 transforms divergent light emitted by the light source 111 into collimated light. The collimated light strikes, through an unevenness correction plate 113, a liquid crystal panel 15 which performs spatial light modulation, and the modulated light is enlarged by a projection lens 115 and projected onto a screen (not shown).

The two-dimensional white LED array of the light source 111 is a light source including LEDs arrayed in a two-dimensional matrix, and is obtained by, for example, horizontally aligning 10 LEDs and vertically aligning 5 LEDs. A luminous flux from each LED is divergent light, and is therefore transformed into collimated light using the lens array 112. This is done to prevent the luminous fluxes from the respective LEDs from overlapping each other too much. The luminous fluxes from the respective LEDs are guided to slightly overlap each other to make their boundaries inconspicuous, as described above. However, too much overlapping makes it difficult to control the luminous fluxes for each block. However, once the luminous fluxes are transformed into collimated light, they do not overlap each other too much even when various types of optical processing including reduction, reflection, and enlargement are done in a succeeding optical system.

The unevenness correction plate 113 normally reduces the imbalance (unevenness) of light from the light source 111, but may be omitted when unevenness correction is performed by multiplying the data displayed on the liquid crystal panel 15 by the reciprocal of the unevenness component of the light source 111.

Only immediately after the light is optically modulated by the liquid crystal panel 15, it can also be corrected to collimated light by the lens array 112, so the lens array 112 may be disposed in the succeeding stage of the liquid crystal panel 15.

The use of a two-dimensional LED array as a light source is advantageous in terms of simplifying the mechanism. However, it is difficult to two-dimensionally array a large number of LEDs with a high density, so the use of such an array is suitable for a compact projection apparatus with a small number of blocks. Alternatively, a large number of blocks may be used for a relatively large-sized projection apparatus. An example in which light is controlled using a small number of blocks will be described below.

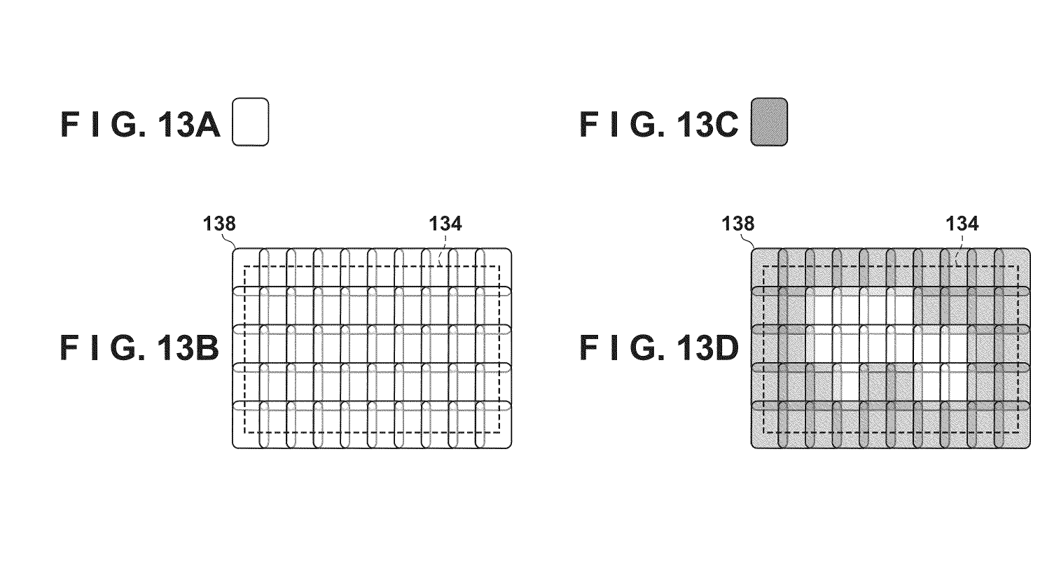

The light emitting states of LEDs according to the sixth embodiment will be described with reference to schematic views shown in FIGS. 13A to 13D. FIG. 13A shows a luminous flux region corresponding to one LED in full light emission, and FIG. 13B shows a luminous flux region 138 of a two-dimensional LED array and a display region 134 on the liquid crystal panel 15 in full light emission.

Also, FIG. 13C shows a luminous flux region corresponding to one LED in half light emission, and FIG. 13D shows a luminous flux region 138 of a two-dimensional LED array and a display region 134 on the liquid crystal panel 15 in block control.

Although FIGS. 13A to 13D illustrate an example in which 10 (horizontal)×5 (vertical) blocks are used for the sake of simplicity, a large number of blocks are preferably used to attain excellent image quality, as described above.

The luminous flux region corresponding to one LED (FIGS. 13A and 13C) has an area larger by, for example, 20% than that obtained by dividing the entire area of the luminous flux region 138 by the number of vertical and horizontal blocks, and the light distribution characteristics of the LED device are adjusted so that the peripheral portion of the luminous flux region becomes dark. With this operation, the vertical and horizontal LED luminous flux regions overlap each other, as shown in the luminous flux region 138 of the two-dimensional white LED array. As a result, since luminous fluxes of light smoothly overlap each other in adjacent regions in both the vertical and horizontal directions, it is possible to prevent hindrances such as streak interference generated between adjacent regions.

The amounts of light emission by the LEDs are controlled (luminous flux control) assuming that a full light emission region is present at the central portion of the luminous flux region 138 in an indeterminate form, while a half light emission region is present in other portions, as shown in the luminous flux region 138 of the two-dimensional LED array in block control (FIG. 13D).

With an increase in luminance of LEDs, a sufficient amount of luminous flux can be obtained for use in, for example, a home theater even in a projection apparatus which uses one LED array.

### Seventh Embodiment

A projection apparatus according to the seventh embodiment of the present invention will be described below. Note that the same reference numerals as in the first to sixth embodiments denote the same constituent elements in the seventh embodiment, and a detailed description thereof will not be given.

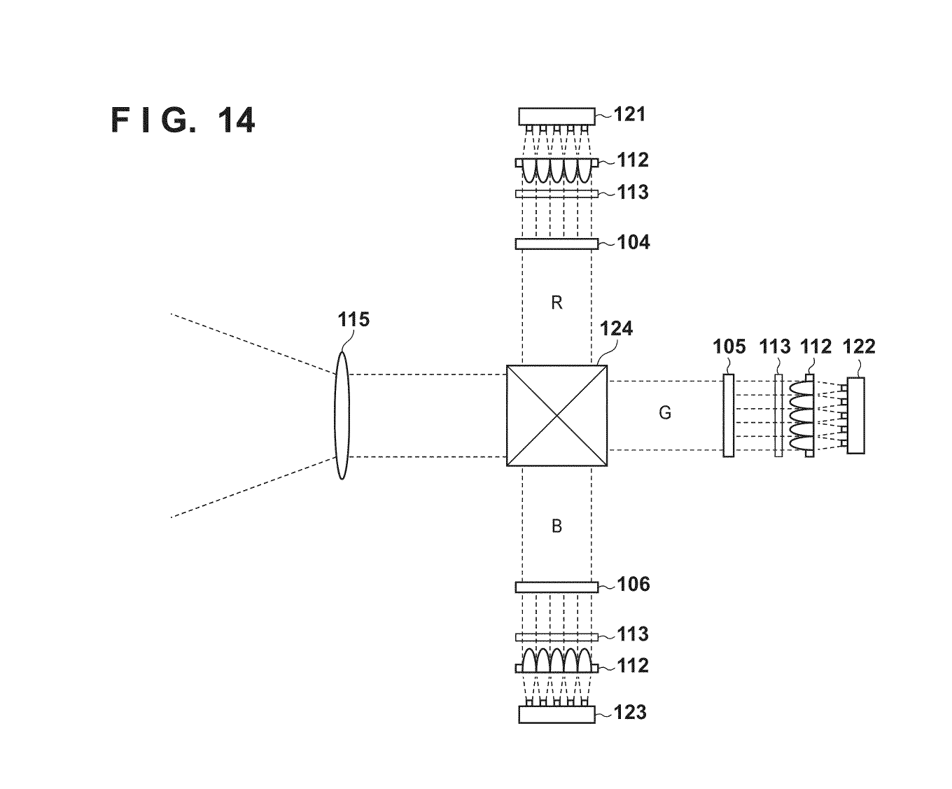

The projection apparatus according to the seventh embodiment employs two-dimensional LED arrays of three colors as a light source, and performs spatial light modulation using three liquid crystal panels. The mechanism configuration of the projection apparatus according to the seventh embodiment will be described with reference to FIG. 14.

Referring to FIG. 14, a light source 121 has a two-dimensional red LED array, a light source 122 has a two-dimensional green LED array, and a light source 123 has a two-dimensional blue LED array. A prism 124 is a combining prism which combines luminous fluxes of the three colors.

R light from the light source 121 is transformed into collimated light by a lens array 112, and strikes an R liquid crystal panel 104 through an unevenness correction plate 113. Similarly, G light from the light source 122 strikes a G liquid crystal panel 105, and B light from the light source 123 strikes a B liquid crystal panel 106. After spatial light modulation by the liquid crystal panels, the luminous fluxes of the three colors are combined by the prism 124, and projected onto a screen (not shown) upon being enlarged by a projection lens 115.

In the seventh embodiment, since three two-dimensional LED arrays are used, a sufficient amount of luminous flux can be obtained, and heat sources can be distributed to allow independent cooling of the respective light sources, thus facilitating cooling.

### Eighth Embodiment

A projection apparatus according to the eighth embodiment of the present invention will be described below. Note that the same reference numerals as in the first to seventh embodiments denote the same constituent elements in the eighth embodiment, and a detailed description thereof will not be given.

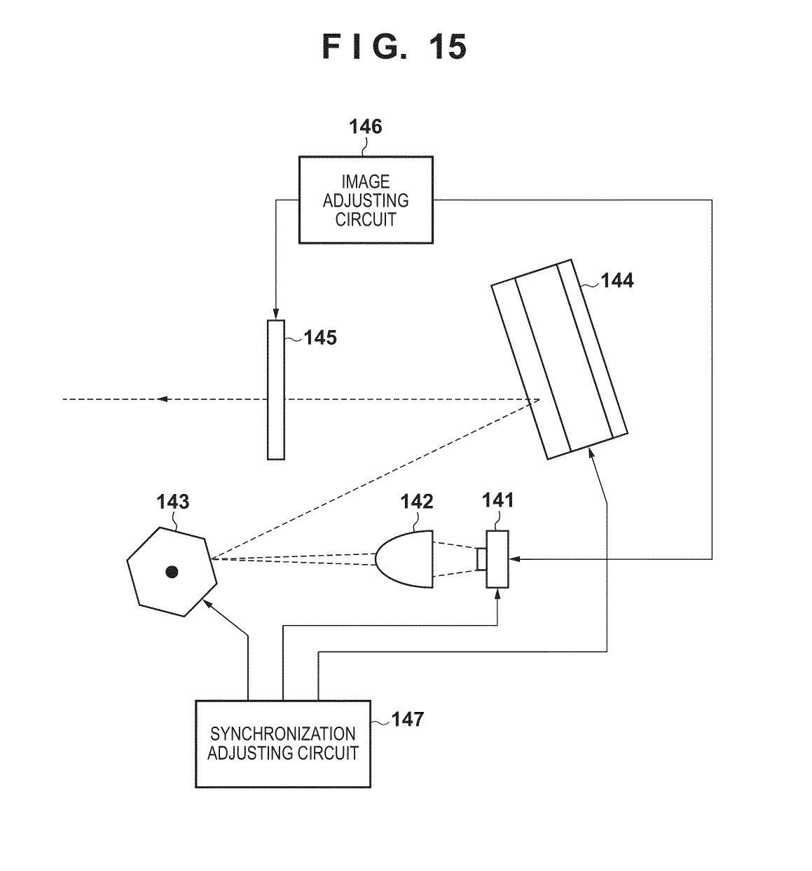

The projection apparatus according to the eighth embodiment employs white LEDs as a light source to perform two-dimensional optical scanning, and performs spatial light modulation using a liquid crystal panel. The mechanism configuration of the projection apparatus according to the eighth embodiment will be described with reference to FIG. 15.

Referring to FIG. 15, a light source 141 has white LEDs. A condenser 142 condenses light from the light source 141. A polygon mirror 143 linearly scans a block-like luminous flux, while a polygon mirror 144 two-dimensionally scans a linear luminous flux. A liquid crystal panel 145 serves as a spatial light modulation device.

An image adjusting circuit 146 controls the liquid crystal panel 145 and light source 141 in accordance with image data to be displayed. A synchronization adjusting circuit 147 is configured to match the timings of the light source 141, polygon mirror 143, and liquid crystal panel 145.

Light from the white LEDs of the light source 141 diverges toward the front, and is therefore transformed into block-like collimated light upon being condensed by the condenser 142. The polygon mirror 143 is then rotated to linearly scan the block-like collimated light incident on the polygon mirror 143. The polygon mirror 144 rotates in a direction perpendicular to that of rotation of the polygon mirror 143. Upon rotation of the polygon mirror 144, linear collimated light incident on the polygon mirror 144 is two-dimensionally scanned. The two-dimensionally scanned light strikes the liquid crystal panel 145, and a luminous flux modulated by an image displayed on the liquid crystal panel 145 is output. The output luminous flux is enlarged by a projection lens (not shown), and projected onto a screen (not shown).

Note that as for the scanning directions of the polygon mirrors 143 and 144, the line direction is defined on the abscissa, and the scanning direction is defined on the ordinate with respect to the liquid crystal panel 145. Also, although either of the two polygon mirrors may be used for the vertical or horizontal direction, the polygon mirror 143 is used for the horizontal direction while the polygon mirror 144 is used for the vertical direction in this embodiment.

The image adjusting circuit 146 dynamically controls the amount of light emission by the white LED of the light source 141 for each block to change the display gradation of the liquid crystal panel 145 in accordance with the amount of luminous flux obtained by the control operation. With this operation, a high-contrast projection image can be obtained, as in the above-mentioned embodiments.

The synchronization adjusting circuit 147 synchronizes the control timing of a luminous flux from the light source 141, the rotation angles of the two polygon mirrors, and the timing at which the display of the liquid crystal panel 145 is rewritten. With this operation, a projection image free from an image oscillation can be obtained.

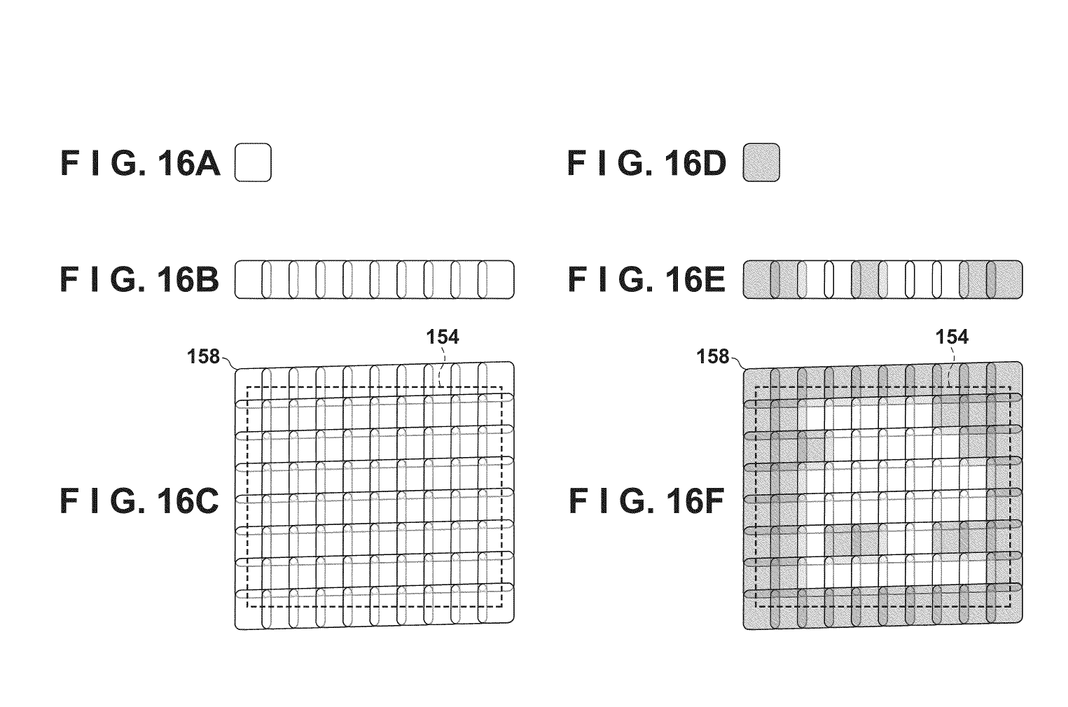

The light emitting states of the LEDs will be described with reference to schematic views shown in FIGS. 16A to 16F. FIG. 16A shows a luminous flux region of the LED in full light emission, FIG. 16B shows a luminous flux region of the LEDs in full light emission when one-dimensional scanning is done, and FIG. 16C shows a luminous flux region 158 and a display region 154 on the liquid crystal panel 145 in full light emission when two-dimensional scanning is done.

Also, FIG. 16D shows a luminous flux region of the LED in half light emission, FIG. 16E shows a luminous flux region when one-dimensional scanning is done upon block control, and FIG. 16F shows a luminous flux region 158 and a display region 154 on the liquid crystal panel 145 when two-dimensional scanning is done upon block control.

Although FIGS. 16C and 16F illustrate an example in which 10 (horizontal)×8 (vertical) blocks are used for the sake of simplicity, a large number of blocks are preferably used to attain excellent image quality, as described above. In the eighth embodiment, since blocks are used only in temporal control of the LED, finer control can be done, so it is desired to use about 50 (horizontal)×100 (vertical)=5000 blocks.

The luminous flux region of the LED (FIGS. 16A and 16D) becomes that (FIGS. 16B and 16E) one-dimensionally scanned by the polygon mirror 143. The one-dimensionally scanned luminous flux region further becomes the luminous flux region 158 two-dimensionally scanned by the polygon mirror 144. Based on the relationship of the two-dimensional scanning time, the luminous flux region 158 is controlled by the synchronization adjusting circuit 147 so as to cover the display region 154 on the liquid crystal panel 145 in a parallelogram.

The overlapping state of light between adjacent blocks is the same as described with reference to FIGS. 5A and 5B, and luminous fluxes of light smoothly overlap each other in both the vertical and horizontal directions, so it is possible to prevent hindrances such as streak interference generated between adjacent regions.

In block control of the amount of luminous flux, the image adjusting circuit 146 calculates the required amount of luminous flux for each block. When the LED performs full light emission, a luminous flux region shown in FIG. 16A is obtained. However, when the LED performs half light emission, a luminous flux region shown in FIG. 16D is obtained. When the LED emits light in another amount, a luminous flux region corresponding to this amount is obtained.

A luminous flux region (FIGS. 16B and 16E) one-dimensionally scanned by the polygon mirror 143 is obtained while the image adjusting circuit 146 changes the amount of light emission by each LED. A luminous flux region 158 two-dimensionally scanned by the polygon mirror 144 is obtained. With this operation, a light source having undergone luminous flux amount control is obtained for each small block.

Although an example in which a white LED and a color liquid crystal panel are used has been given in the eighth embodiment, a projection apparatus similar to that in the eight embodiment can be obtained even using a combination of a light source such as LEDs of three colors: R, G, and B and a color liquid crystal panel or three monochrome liquid crystal panels.

In the eighth embodiment, the total amount of luminous flux is relatively small, but a larger number of control blocks for the amount of luminous flux can be set, so a projection image superior in contrast can be obtained.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-131393 filed Jun. 8, 2012, which is hereby incorporated by reference herein in its entirety.

What is claimed is:

1. A projection apparatus comprising:
a light source;
an optical scanner configured to transform light from the light source into a two-dimensional luminous flux;
an optical modulator configured to perform spatial light modulation of the luminous flux incident from the optical scanner, based on image data; and
a controller configured to control an amount of light emission by the light source for each predetermined control unit, based on a gradation distribution of the image data.

2. The apparatus according to claim 1, wherein the optical scanner includes a polygon mirror.

3. The apparatus according to claim 1, wherein a plurality of predetermined control units are arranged in a line direction of a screen, and the light source comprises light emitting devices equal in number to the predetermined control units.

4. The apparatus according to claim 3, wherein the light source includes a white light emitting diode array formed by linearly arranging white light emitting diodes, and the optical scanner changes a position of the white light emitting diode array.

5. The apparatus according to claim 3, wherein the light source includes a white light emitting diode array formed by linearly arranging white light emitting diodes, and the optical scanner changes a tilt angle of the white light emitting diode array.

6. The apparatus according to claim 3, wherein the light source includes a white light emitting diode array formed by linearly arranging white light emitting diodes, and the optical scanner includes a variable angle prism.

7. The apparatus according to claim 1, further comprising a synchronizer configured to synchronize operations of the light source, the optical scanner, and the optical modulator.

8. The apparatus according to claim 1, wherein the light source includes a plurality of light emitting diode arrays configured to emit luminous fluxes of three colors: R, G, and B, and the optical modulator comprises a plurality of optical modulators configured to perform spatial light modulation of the luminous fluxes of the three colors, respectively.

9. A projection apparatus comprising:
a light source which comprises a white light emitting diode array formed by two-dimensionally arranging white light emitting diodes;
a condenser configured to condense light from the light source to form collimated light;
an optical modulator configured to perform spatial light modulation of a luminous flux incident from the condenser, based on image data; and
a controller configured to control an amount of light emission by the light source for each predetermined control unit, based on a gradation distribution of the image data.

10. A projection apparatus comprising:
a light source which comprises a plurality of light emitting diode arrays formed by two-dimensionally arranging light emitting diodes for each of three colors: R, G, and B;
a condenser configured to condense light from the light source to form collimated light;
an optical modulator configured to perform spatial light modulation of a luminous flux incident from the condenser, based on image data; and
a controller configured to control an amount of light emission by the light source of each color for each predetermined control unit, based on a gradation distribution of the image data.

11. The apparatus according to claim 1, further comprising an adjustor configured to adjust a gradation value of image data corresponding to an overlap portion of luminous fluxes with an adjacent projection apparatus.

12. The apparatus according to claim 11, wherein the controller performs an edge blending process in which the amount of light emission in the overlap portion is controlled based on a size of the overlap portion, and the number of overlap portions.
